(19) United States
(12) Patent Application Publication
(10) Pub. No.: US 2012/0312574 A1
(43) Pub. Date: Dec. 13, 2012

(54) SYSTEM FOR CONVEYING A FLUIDIC MEDIUM IN A POWER TOOL

(75) Inventors: Torsten LUETHJE, Grosshansdorf (DE); Klaus SCHOLZ, Hamburg (DE); Gunnar SALOMON, Hamburg (DE)

(73) Assignee: MAKITA CORPORATION, Anjo-shi (JP)

(21) Appl. No.: 13/482,039

(22) Filed: May 29, 2012

(30) Foreign Application Priority Data
Jun. 8, 2011 (DE) 202011050393.3

(51) Int. Cl. F02B 63/02; B60K 15/035

(52) U.S. Cl. 173/213; 220/746; 123/198 E

(57) ABSTRACT

A system for conveying at least one fluid medium in a power tool includes at least one structural element for forming a frame and/or a part of a housing of the power tool. The fluid medium is conveyed by at least one fluidic connection in the power tool. In the structural element there is at least one channel for forming the fluidic connection and through which the fluid medium can be conveyed.

The present invention relates to a system for conveying at least one fluid medium in a power tool with at least one structural element, more particularly for forming a frame and/or a housing of the power tool, and whereby the fluid medium is conveyed in the power tool by means of at least one fluid connection.

### PRIOR ART

Known systems for conveying fluid media in a power tool are based on hose connections, for example between the tank of the power tool and the device for mixture preparation, for example the carburettor. The fluid media can also comprise oils or also water, so that the fluid media are designed as hydraulic fluids. Also known are hose pipelines which convey the fluid media in the form of thermal fluids and are designed, for example, as ventilating and venting lines for the tank of the power tool. The thermal medium is the air which has to be introduced into a tank when a negative pressure develops in the tank due to the removal of the fuel from the tank. If an excess pressure occurs in the tank, for example through heating of the tank and the fuel, the tank can be vented via the hose pipeline so that the fluid medium can also be formed by fluid vapours, for example.

The hose pipelines of known systems for conveying fluid media in a power tool are in most cases arranged in the interior, covered by a housing of the power tool for example. The hose pipelines can, for example, be fastened to the frame of the power tools, whereby the frame and/or the housing of the power tools can here be described as structural elements.

Disadvantageously, the known systems for conveying fluid media in power tools have drawbacks, more particularly in that systems based on hose pipelines are laboriously designed and are subject to faults. For example, the hose pipeline can become damaged, or a fastening end of the hose pipelines may accidentally become detached from the tank and/or the component on which the hose pipeline is conveying the fluid medium. Another disadvantage arises through the large number of required sealing points for connecting a hose pipeline, whereby rubber-like materials for creating the sealing point often lead to gas escapes, as a result of which further disadvantage of the known systems for conveying fluid media in a power tool come about.

DE 103 22 641 A1 shows a system for conveying a fluid medium in a power tool, and a tank housing is provided which adjoins an air purification unit through which the air is passed that is drawn in by the combustion motor, whereby via a venting device the tank housing is connected to the clean air side of the air purification unit, whereby a container wall of the tank housing and a housing wall of the air purification unit are adjacent to each other and the venting device has a continuous venting opening which passes through the container wall and the housing wall. This creates a hose-free fluidic connection between the tank and the air purification unit, whereby the components for creating the fluidic connection do not serve as structural elements, as components for storing and/or for treating the fluid medium do so in themselves.

DE 44 27 738 B4 shows another system for conveying fluid media in a power tool that is based on components specially designed for conveying the fluid medium. For example a venting component is envisaged that connects a chamber, which forms the fuel tank, and another chamber, an equalisation container. However, the venting component is specially envisaged for creating the venting line so that again a laborious embodiment of the system for conveying the fluid medium is produced.

### DESCRIPTION OF THE INVENTION: AIM, SOLUTION, ADVANTAGES

It is therefore the aim of the present invention to create a system for conveying at least one fluid medium in a power tool that avoids the above drawbacks and is simply designed, more particularly in order to remove at least one fluid medium from a tank and/or to introduce it into a tank.

This aim is achieved on the basis of a system in accordance with the introductory section of claim 1 in connection with the characterising sections. Advantageous further embodiments of the invention are set out in the characterising features dependent claims.

The invention includes the technical teaching that at least one channel is formed in the structural element to form the fluidic connection and through which the fluid medium can be conveyed.

The invention is based on the idea of simplifying the system for conveying fluid media in the power tool in such a way that a component, more particularly a hose pipeline, a pipeline or a components in which a channel for conveying the fluid medium is specially formed, can be omitted. Indeed, the opportunity is used to further develop a structural element of the power tools, for example the frame and/or a part of the housing of the power tools, in such a way that the fluid medium can be conveyed in the structural element itself. For this, in accordance with the invention it is envisaged that a channel is formed in the structural element that is not just fastened to the structural element in the form of a hose pipeline or taken through hollow space in the structural element, but is specially designed to convey the medium in the structural element.

Advantageously the channel can open into the tank of the power tool in which, for example, fuel, oil and/or water can be stored. The channel should not just be understood as an opening between, for example, a tank, an overflow chamber, an equalisation chamber and an air inlet tract of the power tool or other space. In accordance with the present invention the channel is longitudinal and extends through the structural element. The structural element can more particularly be in shell form, and the channel preferably does not extend perpendicularly through the wall of the shell form, but runs parallel to the wall, or along the wall.

The structural element can also advantageously be made of a plastic material, whereby the channel for conveying the fluid medium is produced by internal pressure injection moulding, more particularly by gas internal pressure injection moulding. Internal pressure injection moulding is a special form of injection moulding and the structural element can initially be injection moulded in the conventional way, and in an accompanying or subsequent processing step gas or other medium generates a pressure in a still fluid area of the molten plastic material in order to create a hollow space. In this way an internal channel can be produced in a plastic injection moulded component without having to provide a conventional moulding core. More particularly in that the plastic material first hardens on the wall of the injection moulding tool, the advantage can be used that the channel forms in the interior of the structural element as the plastic melt is still fluid in the internal area.

Preferably the channel in the structural element extends between the tank and a device for mixture preparation for the combustion motor. More particularly the channel can also be in the tank and the structural element and the tank can be designed in one part and formed by the same element. As a further advantage a first section of the channel can be in the tank and a further section of the channel in the structural element, and the openings of the channels can be made to coincide fluidically through the structural element being arranged correspondingly adjacent to the tank.

The fluidic medium can be formed by fuel, whereby at least one further channel is provided in a structural element for ventilating and venting the tank, so that the fluid medium is more particularly formed by air. On venting the tank the fluid medium can be formed by fuel vapours. In this way a tank can be connected to more than one channel which extends through a structural element, whereby via a first channel fuel can be taken from the tank and via a second channel the tank can be ventilated and vented.

In accordance with further advantageous form of embodiment of the invention, the channel can have a channel opening on which at least the device for mixture preparation can be mounted in a sealed manner. In addition, the channel can be provided in a structural element and at the opening of the channel in the structural element the tank can be arranged. The tank can comprise an opening or an outlet valve or suchlike, arranged adjoining the channel opening. Preferably a sealing means can be provided which creates a fluidically tight connection of the channel with the device for mixture preparation and/or with the tank.

The structural element can have at least one thickened section, preferably on the inside of a wall, with a channel being provided in the thickened section. Alternatively the structural element can be of a material thickness so that the channel can be formed in structural element with a sufficient cross-section. If the thickened section is on the inside of a wall of the structural element, the thickened section is not visible from the outside of the power tool. The thickened section to form the channel can already be taken into account in the injection moulding of the structural element so that forming the channel involves no additional cost.

In accordance with a further advantageous form of embodiment the structural element forms a wall of the tank, whereby there is at least one channel in or on the wall of the channel which particularly opens into a base area of the tank. The tank can for example be in the form of two half shells, which can be arranged on top of each other to form a hollow space, and can for example be welded to each other. In this way the two half shells can be sealed together and the hollow space forms the tank. Each of the half shells thus forms a structural element and on the inside of the half shell a channel can be formed, which extends at least partially through the tank. Preferably the channel extends into the base area of the tank in order to draw in fuel in the base area. The channel runs into the upper section, facing away from the base area of the tank and on the upper side of tank can have a channel opening on which, for example, the device for gas preparation can be arranged.

At the mouth of the channel a fuel filter can be fitted. More particularly, the opening of the channel can be the opening which opens into to the base area of the tank and on which the fuel filter is arranged, so that the fuel can be drawn from the tank through the filter and the fuel filter filters the fuel that is drawn in.

As an additional advantage the tank can have at least two tank chambers, whereby at least one tank chamber extends in the structural element between the two tank chambers. For example, the power tool can comprise a main tank, but also an equalisation container, or a fuel overflow chamber is envisaged which has to be directly or indirectly connected to the main tank. At least one channel can be formed in the structural element which opens into the fuel overflow chamber. Thus, in the context of the present invention, with a channel in the structural element a connection can be created between various containers in which fluid media, for example, fuel, water or air are contained.

### BRIEF DESCRIPTION OF THE DRAWINGS

Further measures improving the invention are set out below in more detail together with the description of preferred examples of embodiment of the invention with the aid of the drawings.

FIG. 1 shows a perspective view of an example of embodiment of a structural element with a channel integrated in the structural element and a device for mixture preparation in an unassembled arrangement,

FIG. 2 shows the example of embodiment of the structural element in FIG. 1 with a device for mixture preparation which is arranged on an opening of the channel,

FIG. 3 shows a further example of embodiment of a structural element with an internal channel and

FIG. 4 shows a perspective view of a power tool with a system for conveying fluid media in accordance with the present invention.

### PREFERRED EXAMPLE OF EMBODIMENT OF THE INVENTION

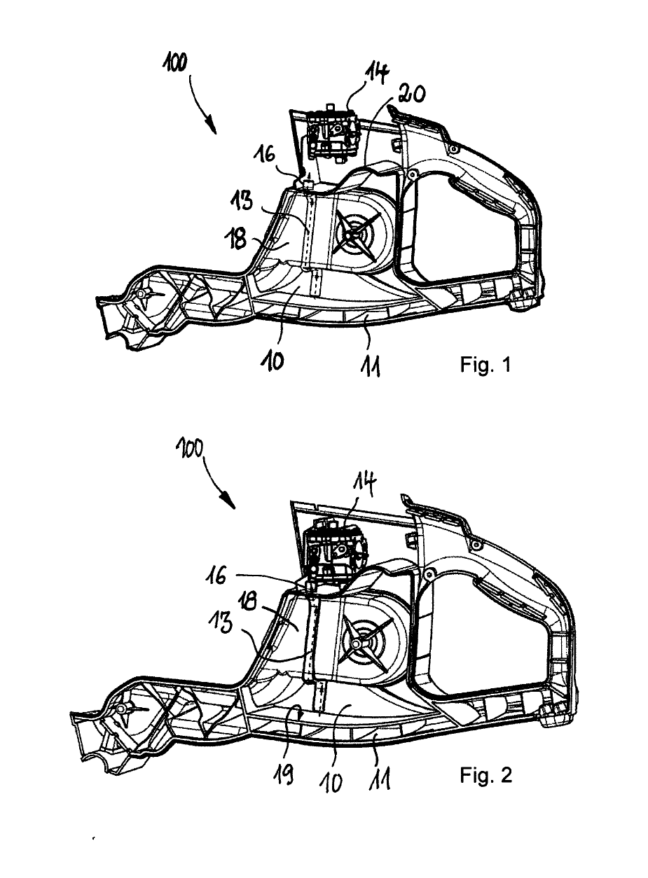

FIG. 1 shows a perspective view of a system 100 for conveying a fluid medium in a power tool. The power tool has various components which are at least in part formed by structural elements, and for example, can constitute the frame or a housing section of the power tool. As an example the figure shows a structural element 11 in the form of a half shell made of a plastic material and produced in an injection moulding process. The structural element 11 forms a first half of a housing section of the power tool, and a further structural element can, in for example a mirror-image arrangement, be superimposed on the shown structural element 11. In doing so a hollow space can be formed between the structural elements 11, through which a tank 10 for holding fuel to operate the power tool can be formed.

In the region of the wall of the tank 10 in the structural element 11 a channel 13 in accordance with the present invention is incorporated. The medium to be conveyed through the channel 13 is the fuel that is contained in the tank 10. The fuel can be drawn through the channel 13 and the fuel can be supplied to a device 14 for mixture preparation, more particularly a carburettor.

The device 14 for mixture preparation is shown in a suspended arrangement before the upper end of the channel 13 whereby the upper end of the channel 13 extends through a tank wall 20 which defines the hollow space for forming the tank 10 at the top. The end of the channel 13 is formed by a channel opening 16, and the device 14 for mixture preparation is attached to the channel opening 16 in a sealed manner.

The main part of the channel 13 runs along a wall 18 which is a part of the structural element 11 and forms the wall of the tank 10. The channel 13 is produced in the structural element 11 by way of gas internal pressure injection moulding, whereby the gas internal pressure injection moulding takes place at the same time as, or shortly after, the actual injection moulding process for producing the structural element.

The negative of the geometric shape of the channel 13 is already formed in the injection moulding tool and when the fluid plastic mass is injected into the injection moulding tools it initially hardens in external contact with the injection moulding tool. This results in a phase in the injection moulding in which the core of the plastic mass is still molten. Through injecting a gas at high pressure the channel 13 can be blown in the area of the still molten plastic material without an injection moulding core having to be used.

The shown channel 13 in the structural element 11 can be produced by such a gas internal pressure injection moulding process that producing the channel 13 as a separate part and having to attach it to the structural element 11 can be avoided. In accordance with the invention a structural element 11 with an integrated channel 13 is created, through which the fuel, used as an example, from a tank 10 can be drawn.

FIG. 2 shows the system 100 for conveying fluid media with the structural element 11 in accordance with FIG. 1, whereby the device 14 for mixture preparation is attached to the channel opening 16 of the channel 13.

The tank 10 has a base area 19 and the channel 13 extends from the device 14 into the base area 19 of the tank 10 along the wall 18. The device 14 for mixture preparation can be connected to a combustion motor 5 as shown in the overall view of the power tool 1 in accordance with FIG. 4.

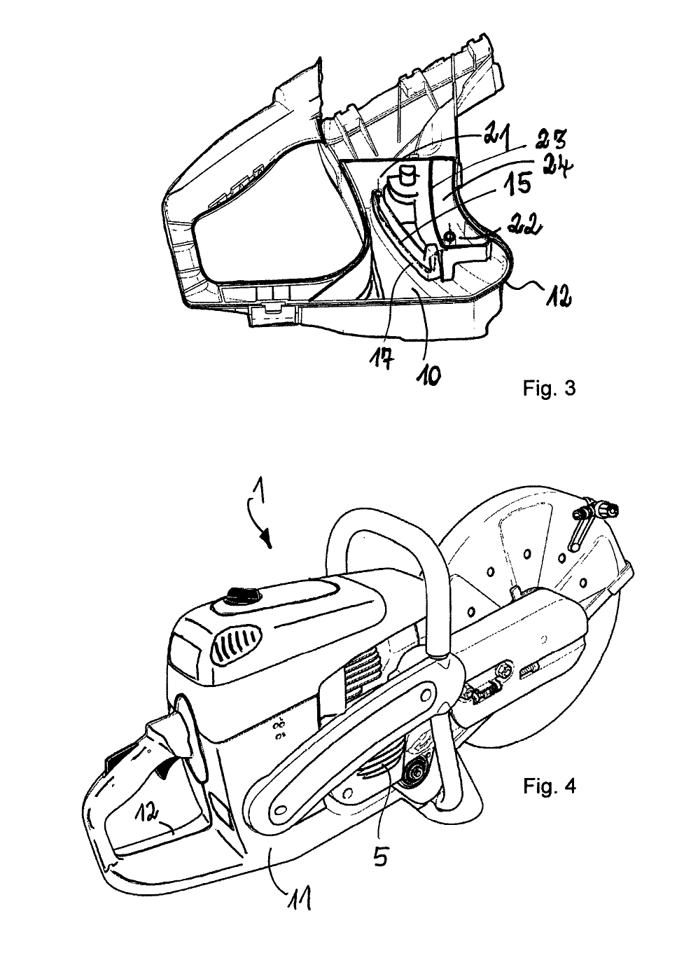

FIG. 3 shows a further example of embodiment of a structural element 12, in which a channel 15 is again incorporated. The structural element 12 has a thickened section 17 and the channel is 15 incorporated in the thickened section 17. The shown channel 15 in the structural element 12 is or ventilating and venting a tank 10, and the channel 15 runs between a first opening 21 and a second opening 22 and thereby connects the tank 10 with a fuel overflow chamber 24.

Both the tank 10 and the fluid overflow chamber 24 can already be formed by way of appropriate geometric shaping of the structural element 12, and if a structural element which corresponds to the shown structural element 12 to couple with it is attached to the shown structural element, both the tank 10 as well as the fuel overflow chamber 24 are formed. Here, in a first structural element 12 a channel 13, for example, can be formed for drawing in the fuel through the device 14 for mixture preparations, and a further channel 15 can be used to ventilate and vent the tank 10 and/or for the fluidic connection of the tank 10 with a fuel overflow chamber 24.

The result is a fluidic system 100 in the power 1 as shown in FIG. 4 without the necessity for further individual parts, hose pipelines and other connection elements. Particularly advantageously the channels 13 and 15 as well as the channel openings 16, 21 and 22 are rigidly formed on the structural elements 11 and 12 and further components, for example a device 14 for mixture preparation, but also fuel filters, the device 14 for mixture preparation, connection piece and suchlike can be held on the 11 and 12 without nipples, connection pieces or hose clips and suchlike being required to connect hose pipelines to the components.

Thus, for example, the combustion motor 5 with the device for mixture preparation (not shown in the perspective view) can be connected to a tank within the housing that is formed by the structural elements 11 and 12 without a hose pipeline.

The invention is not restricted to the above preferred examples of embodiment. Rather, a number of variations are conceivable which make use of the described solutions, even in fundamentally different designs. All features and/or advantages, including structural details or spatial arrangements set out in the claims, the description or the drawings can be essential to the invention individually or in the most varied of combinations.

### LIST OF REFERENCES

100 System for conveying a fluid medium
1 Power tool
5 Combustion motor
10 Tank
11 Structural element
12 Structural element
13 Channel
14 Device for mixture preparation
15 Channel
16 Channel opening
17 Thickened section
18 Wall
19 Base area
20 Tank wall
21 Opening
22 Opening
23 Partition wall
24 Fuel overflow chamber

1. System for conveying at least one fluid medium in a power tool with:
at least one structural element more particularly for forming a frame and/or a part of a housing of the power tool and
whereby the fluid medium is conveyed by at least one fluidic connection in the power tool, characterised in that in the structural element there is at least one channel for forming the fluidic connection and through which the fluid medium can be conveyed.

2. System in accordance with claim 1, characterised in that at least one tank is provided, whereby the fluid medium can be introduced into and/or removed from the tank through the channels in the structural element.

3. System in accordance with claim 1, characterised in that the structural element is made of a plastic material, whereby the channel for conveying the fluid medium is produced by internal pressure injection moulding, more particularly by gas internal pressure injection moulding in the structural element.

4. System in accordance with claim 2, characterised in that the channel in the structural element extends between the tank and a device for mixture preparation for the combustion motor.

5. System in accordance with claim 2 characterised in that the fluid medium is in the form of fuel, whereby at least one further channel is provided in a structural element which serves to ventilate and vent the tank so that the fluid medium is formed by air.

6. System in accordance with claim 4 characterised in that the channel has a channel opening on which at least the device for the mixture preparation can be mounted in a sealable manner.

7. System in accordance with claim 1, characterised in that the structural element has a least one thickened section, preferably on an inside of the wall, in which the at least one channel is formed.

8. System in accordance with claim 2, characterised in that the structural element forms a wall of the tank, whereby there is at least one channel in or on the wall of the tank more particularly opening into a base area of the tank.

9. System in accordance with claim 8 characterised in that a fuel filter can be mounted on an opening of the channel.

10. System in accordance with claim 2, characterised in that the tank has at least two tank chambers whereby at least one channel in the structural element extends between the at least two tank chambers.

11. System in accordance with claim 1, characterised in that the power tool has at least one fuel overflow chamber, whereby at least one channel is provided in the structural element which opens into the fuel overflow chamber.
